(19) United States
(12) Patent Application Publication
(10) Pub. No.: US 2018/0370826 A1
(43) Pub. Date: Dec. 27, 2018

(54) METHOD AND APPARATUS FOR PROVIDING RE-MINERALIZED WATER

(71) Applicant: NESTEC S.A., Vevey (CH)

(72) Inventors: Renaud Sublet, Vittel (FR); Mikael Uyttewaal, Bulgneville (FR)

(73) Assignee: NESTEC S.A., Vevey (CH)

(21) Appl. No.: 16/062,374

(22) PCT Filed: Dec. 15, 2016
(86) PCT No.: PCT/EP2016/081127

§ 371 Date: Jun. 14, 2018

(30) Foreign Application Priority Data
Dec. 16, 2015 (EP) 15200355.4

(51) Int. Cl. C02F 1/68; C02F 1/44

(52) U.S. Cl. CPC C02F 1/68; C02F 1/441; C02F 2209/003; C02F 2101/206; C02F 2209/06; C02F 2301/043; C02F 2209/05

(57) ABSTRACT

A method for providing purified, re-mineralized water (127) in magnesium and calcium ions comprises the steps of providing a flow of feedwater (101) and purifying and/or demineralizing it by a purifying and/or demineralizing process to produce a flow of purified, demineralized water (113); injecting carbon dioxide into said purified, demineralized water (113) to produce a flow of carbon-dioxide-enriched water (123); and finally passing the carbon-dioxide-enriched water (123) through a re-mineralizer (124) which comprises a dolomite medium (126), thereby producing a simultaneous remineralizing of the water in Calcium and Magnesium leading to a flow of purified, re-mineralized water (127).

### FIELD OF THE INVENTION

The present invention concerns an apparatus for infusing purified and/or demineralized water with a mineral substance, as well as a method for operating such an apparatus.

### BACKGROUND OF THE INVENTION

In the arts of water treatment, it is well known to purify water for human consumption and/or industrial use by implementing specific purifying process. Purifying processes use for example the process of filtration, sediment, bacteria digestion, distillation or reverse osmosis. In reverse osmosis for example, a volume of liquid containing contaminants is introduced into a chamber on one side of a semi-permeable membrane (i.e. having pores large enough to pass the molecules of the solvent liquid but not those of the solute contaminant). By pressurizing the liquid above its osmotic pressure, the solvent liquid molecules will diffuse across the membrane but the solute molecules will remain; the resulting brine is then discarded and the solvent liquid thus purified is retained.

Such reverse-osmosis systems can be configured to produce purified water from virtually any source, and remove many of the contaminants contained therein, including dissolved mineral ions, with great effectiveness.

While this is advantageous for many reasons and in many applications, it is nonetheless imperfect for the production of drinking water. Specifically, in the case of a reverse-osmosis process, it is not selective, i.e. it removes all dissolved mineral ions, both those which are desirable for health and taste along with those which are not. In the end, the water is a demineralized water free of any mineral ions.

Besides, in some specific locations, the water coming out directly from the spring contains very few minerals and may sometimes also be considered as almost demineralized.

It is therefore known to pass the demineralized water through a subsequent step for replenishing certain of the minerals lost and adding other desirable minerals not present in the water prior to the start of the purification process.

In particular, the elements calcium (ion Ca²⁺) and magnesium (Mg²⁺), and the polyatomic ion bicarbonate (HCO₃⁻) are particularly desirable, as their presence in drinking water may contribute to establishing and maintaining physical and mental health. These ions are also partly responsible for creating a pleasant taste in the drinking water.

One such means of doing this is to dissolve a mixture of mineral salts into the water. Commonly employed additives include calcium chloride (CaCl₂)), magnesium sulphate (MgSO₄) or chloride (MgCl₂), and bicarbonate of sodium (NaHCO₃) or potassium (KHCO₃).

However, the use of such salts will result in the presence of unwanted chloride, sulphate, sodium, and potassium ions, which negatively affect the taste of the water by bringing a bitter and/or salty taste in the final product and, at certain quantities, can have deleterious effects on the health of certain sensitive consumers (for people having specific diet for example).

The aim of a remineralizing process is then to re-mineralize demineralized water in ions and minerals establishing and maintaining physical and mental health while avoiding the undesirable ones for taste or health issues. It is therefore desirable to provide a means for re-mineralizing demineralized water with desirable ions, without also adding undesirable minerals, counter-ions and/or compounds such as these or others.

### SUMMARY OF THE INVENTION

To this end, the invention is directed in a first aspect towards a method for providing purified, re-mineralized water in Calcium and Magnesium ions, comprising the steps of providing a flow of feedwater; purifying and/or demineralizing said feedwater by a purifying and/or demineralizing process, thereby producing a flow of demineralized water; injecting carbon dioxide into said demineralized water, thereby producing a flow of carbon-dioxide-enriched water; and passing said carbon-dioxide-enriched water through a re-mineralizer comprising a dolomite medium, thereby producing a simultaneous remineralizing of the water in Calcium and Magnesium leading to a flow of purified, re-mineralized water. Such a method is advantageous in that it will cause the dolomite to dissolve into the water, thereby replacing certain desirable mineral ions that were removed during the reverse-osmosis process. As pure dolomite is composed of anhydrous calcium magnesium carbonate (CaMg(CO₃)₂), the presence of the carbon dioxide in the carbon-dioxide-enriched water will facilitate its dissolution into the water. The demineralized water is thus re-mineralized with the desired calcium, magnesium, and bicarbonate ions without also giving it the undesirable sodium, sulphate, and potassium ions, as is the case with the re-mineralization methods known in the art and discussed above.

Re-mineralization by dolomite is also advantageous in that it provides a simultaneous re-mineralization in at least three important elements, namely, calcium, magnesium and bicarbonate. This simultaneous re-mineralization avoids having several equipment and having to manage several re-mineralization kinetics.

Re-mineralization by dolomite dissolution is also advantageous in that dolomite is a widely-occurring natural mineral substance. It is therefore inexpensive and easy to provide in industrial-scale quantities. Moreover, when provided in a reasonably-pure grade, it can be used in a re-mineralization method essentially as it is, with possibly only a small amount of preparation, e.g. crushing, to give the dolomite medium a uniform grain size.

In method of the invention further comprises a step of measuring the conductivity and/or pH of the purified, re-mineralized water for controlling the injection of carbon dioxide into the demineralized water.

This is advantageous in that the dissolution of the dolomite and, by extension, the amount of calcium and magnesium ions present in the purified, re-mineralized water, is partially dependent on the concentration of CO₂ in the demineralized water. By measuring the pH and conductivity of the water at the exit of the re-mineralizer, and by holding constant other factors contributing to the dolomite dissolution kinetics such as water temperature & flow rate, particle size, etc., a high degree of control over the dissolution of the dolomite and consequently of the mineral content of the purified, re-mineralized water is realized.

It should also be mentioned that pH measurement is also important in connection with the various regulations of purified, re-mineralized water and allows to fully stay within said regulations.

In a preferred embodiment, the method further comprises a step for passing said flow of purified, re-mineralized water through a manganese filter.

This is advantageous in that it will remove any remnant manganese ions, or precipitates of manganese compounds, from the flow of purified, re-mineralized water.

In particular, since ozonation is a common component of water treatment in general, and of reverse-osmosis purification in particular, any manganese impurities present will form an unsightly, foul-tasting manganese dioxide precipitate. In any event, the presence of manganese ions

By disposing a manganese filter in the flow of purified, re-mineralized water, the presence of manganese in the purified, re-mineralized water, whether in solution or precipitate, is greatly reduced or eliminated. The quality of the water produced by the method is thereby augmented.

Advantageously, the manganese filter comprises a manganese dioxide medium.

A filter so configured is advantageous in that it will realize an effective filtration of manganese from the flow of water, while being simple and inexpensive to implement even at high water volumes.

In a possible embodiment, the method further comprises a step for periodically regenerating the manganese filter.

In this way, the effective life of the manganese filter is extended.

The step for periodically regenerating the manganese filter may possibly comprise a backwashing sub-step.

The step for periodically regenerating the manganese filter may also possibly comprise a chemical regeneration sub-step.

Through the application of one or both sub-steps, the manganese filter is purged of the manganese trapped therein, re-establishing the efficacy of the filter and extending its useful life.

In a possible embodiment, the sub-step for chemically regenerating the manganese filter comprises the circulation of chlorine or potassium permanganate through the manganese filter.

This is advantageous in that it will achieve a quick and effective regeneration of the manganese filter, using substances that are readily available and inexpensive.

According to a second aspect, the invention is drawn to purified, re-mineralized water produced by the method as described above.

Such water is advantageous in that it embodies the advantages of the method used to produce it, in particular in that it is provided with an optimal mineral composition in a simple and inexpensive manner.

According to a third aspect, the invention is drawn to an apparatus for providing purified, re-mineralized water in Calcium and Magnesium ions, comprising a feedwater source for providing a flow of feedwater, and a purification and/or demineralizing apparatus for purifying and/or demineralizing said feedwater, thereby producing a flow of purified demineralized water.

According to the invention, the apparatus further comprises a carbon dioxide injector configured to inject carbon dioxide into said flow of purified, demineralized water; and a re-mineralizer disposed downstream of said carbon dioxide injector and comprising a dolomite medium. Such an apparatus is advantageous in that it will realize the re-mineralization as discussed above, in a simple, inexpensive, and reliable manner.

In a preferable embodiment, the apparatus further comprises a conductivity sensor and a pH sensor each disposed in the flow of purified, re-mineralized water at an outlet of the re-mineralizer, such that the operation of the carbon dioxide injector is governed by a feedback loop at least partially dependent on the output of said conductivity sensor and said pH sensor.

This is advantageous in that the dissolution of the dolomite and, by extension, the amount of calcium and magnesium ions present in the purified, re-mineralized water, is partially dependent on the concentration of CO₂ in the demineralized water. By measuring the pH and conductivity of the water at the exit of the re-mineralizer, and by holding constant other factors contributing to the dolomite dissolution kinetics such as water temperature & flow rate, particle size, etc., a high degree of control over the dissolution of the dolomite and consequently of the mineral content of the purified, re-mineralized water is realized.

In a possible embodiment, the re-mineralizer comprises two filter columns disposed in parallel, each of said filter columns comprising a bed of dolomite medium.

This is advantageous in that a sufficient mineralization is achieved at high flow rates.

In addition, the provision of the re-mineralizer in the form of two parallel filter columns improves the reliability of the system, in that one of the filter columns may be temporarily isolated for e.g. regeneration without taking the apparatus off-line. The up-time of the apparatus is thereby maximized.

In another possible embodiment, the re-mineralizer comprises a single filter column comprising a bed of dolomite medium, and a bypass line diverting a portion of the flow of demineralized water around said filter column.

This is advantageous in that the size of the apparatus is minimized. Specifically, by increasing the injection of CO₂, and consequently increasing the dissolution rate of the dolomite, the desired concentration of minerals in the purified, re-mineralized water is achieved.

Preferably, the apparatus further comprises a manganese filter disposed downstream of the re-mineralizer.

Most preferably, the manganese filter comprises a manganese dioxide medium.

This is advantageous in that it will reduce or eliminate the presence of manganese in the purified, re-mineralized water, as discussed above, particularly when a manganese dioxide medium is employed.

In another possible embodiment, the manganese filter and the re-mineralizer are disposed in a filter column, said filter column comprising a bed of dolomite medium and a bed of manganese dioxide medium having a grain size equal to or greater than the grain size of the dolomite medium.

Such an apparatus is advantageous in that it combines a re-mineralization function with a manganese-removal function, in a single filter column. The apparatus is thus more compact, being thereby optimized for implementations where available space and/or installation costs are limiting factors. The advantages of the invention may thus be realized in a greater range of applications, such as point-of-use, foodservice, and other small-scale installations.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 is a schematic depiction of a first embodiment of an apparatus according to the invention;

FIGS. 2A and 2B are schematic detail views of a re-mineralizer with a magnesium filter, according to a second and a third embodiment of the invention, respectively;

FIG. 3 is a schematic depiction of an apparatus according to a fourth embodiment of the invention; and

FIG. 4 is a schematic depiction of an apparatus according to a fifth embodiment of the invention.

### DETAILED DESCRIPTION OF THE INVENTION

The invention will now be discussed in detail with respect to the above-mentioned Figures.

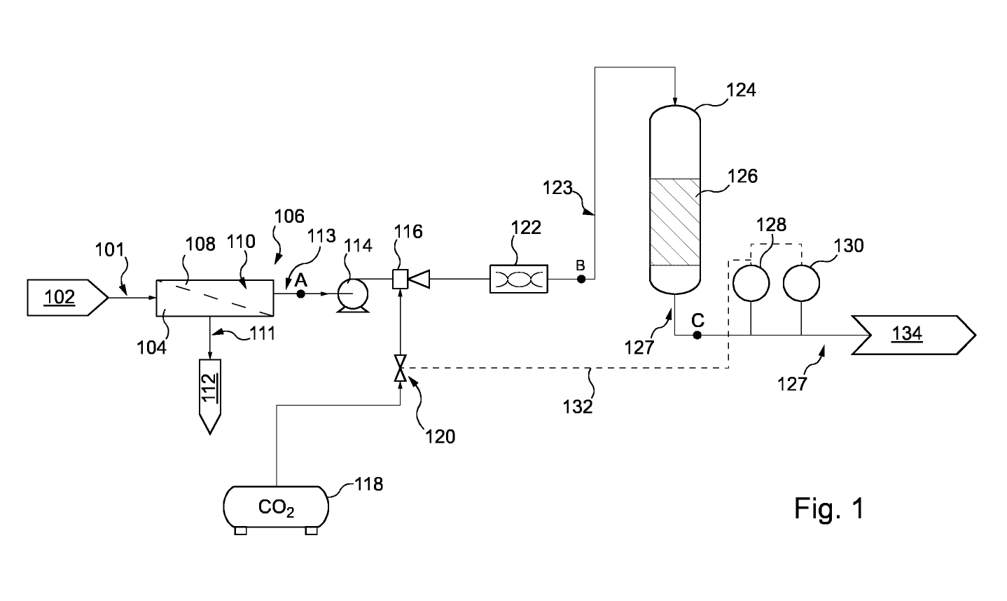

In FIG. 1, there is depicted an apparatus 100 for purifying water. The apparatus 100 is supplied with a flow of feedwater 101 from a feedwater source 102, which is conducted into a high-pressure side 104 of a reverse-osmosis filter 106.

The reverse-osmosis apparatus 106 functions in the same way as those known in the art. The feedwater 101 is pressurized, either by the feedwater source 102 or by an additional pumping means disposed between the feedwater source 102 and the reverse-osmosis filter 106, which raises the pressure of the feedwater 101 above its osmotic pressure. This causes the water molecules in the feedwater 101 to diffuse across a reverse-osmosis membrane 108 in the reverse-osmosis filter 106 to a low-pressure side 110. The contaminants present in the feedwater are drawn off in the form of a concentrate 111, which is disposed e.g. through a drain 112.

In this way most, if not all, of the contaminants present in the feedwater are removed, and at the point A a flow of demineralized water 113 is furnished by the reverse-osmosis filter 106. In particular, where the feedwater 101 is seawater or otherwise contains such an amount of dissolved salt as to render it non-potable, such salt has been effectively eliminated by the reverse-osmosis filtration and discharged to the drain 112 in the concentrate 111. Typically, about ⅙ of the volume of the feedwater 101 is rejected to the drain 112 as concentrate 111, but this may vary depending on the type and concentration of the contaminants found in the flow of feedwater 101.

It will be recognized by those skilled in the art that, in certain situations and depending on the contaminants present in the feedwater and on the system's flow rate and capacity, the reverse-osmosis system will vary from the simple representative version presented here.

In particular, it is well known to provide reverse-osmosis systems with pre-filtration devices, such as sediment filters to prevent larger particles from clogging the membrane of the reverse-osmosis filter. Moreover, disinfection apparatuses may be used to neutralize pathenogenic microorganisms prior to reverse-osmosis filtration. The invention should not, therefore, be construed as being limited to implementations where there is merely a reverse-osmosis filter as depicted here, but instead should be construed as encompassing any or all of such additional pre-filtration and treatment devices as may be appropriate.

From the reverse-osmosis filter 106 the demineralized water 113 is first pressurized by a pump 114, then passed to a carbon dioxide injector 116. The carbon dioxide injector 116 is in communication with a carbon dioxide supply 118 via a servo-operated proportional dosing valve 120.

The dosing valve 120 controls the flow of the carbon dioxide from the carbon dioxide supply and, by extension, the injection of the carbon dioxide into the flow of demineralized water 113 at the carbon dioxide injector 116. There may be further provided a static mixer 122, which promotes the mixing of the carbon dioxide into the demineralized water.

In any case, by the point B the carbon dioxide has been thoroughly mixed into the flow of demineralized water 113, resulting in a flow of carbon-dioxide-enriched water 123 which is then conducted to the re-mineralizer 124.

The re-mineraliser 124 is here provided in the form of a standard particulate filter column, and comprises a dolomite material bed 126 through which the flow of carbon-dioxide-enriched water 123 is conducted.

It will be recognized that the dimensions of the dolomite material bed 126 will depend in large part on the flow rate of the water through the re-mineralizer 124; as a general rule, the dolomite in the dolomite material bed 126 must dissolve into the demineralized water 113 at a rate sufficient to result in the desired contents of 20 milligrams per litre of calcium, 10 milligrams per litre of magnesium, and 120 milligrams per litre of bicarbonate. In a typical, industrial-scale installation, this means that the depth of the dolomite material bed 126 will be between 2.0 and 2.5 meters, and with a media density of between 2.6 and 2.7 kilograms per litre.

As the carbon-dioxide-enriched water 123 flows through the dolomite material bed 126, the elevated carbon dioxide content of the water causes the dolomite to dissolve into the water.

In a re-mineralizer 124 using the exemplary dimensions above, this means that the water is in contact with the dolomite material bed 126 for 15 to 20 minutes, for a linear velocity of between 4 and 6 meters per hour.

In this way, the carbon-dioxide-enriched water 123 is re-mineralized with the desired calcium, magnesium, and bicarbonate ions, and with these ions only. A resulting flow of purified, re-mineralized water 127 then flows from the re-mineralizer 126.

It will be understood that there are a number of factors which might affect the dissolution kinetics within the re-mineralizer 124, including temperature, the dimensions of the dolomite material bed 126, and the flow rate of the carbon-dioxide-enriched water 123 through the re-mineralizer 124.

Downstream of the re-mineralizer 124 are disposed a conductivity sensor 128 and a pH sensor 130, which together serve to assess the level of mineral dissolution in the flow of purified, re-mineralized water.

Specifically, the conductivity meter 128 measures the amount of ions dissolved into the purified, re-mineralized water 127: the demineralized water 113 issuing from the reverse-osmosis filter 106 at point A will have a very low conductivity, generally below 20 pS/cm, but as the calcium, magnesium, and bicarbonate ions dissolve into it the conductivity of the flow of water increases. Thus, conductivity is a good proxy for the mineral concentration in the re-mineralized water 127.

Moreover, the pH of the purified, re-mineralized water 127 is measured to maximize the efficiency of the dissolution process. Specifically, while increasing the concentration of the CO₂ will increase the dissolution rate of the dolomite material bed 126, this increase is constrained by dimensional factors such as the depth of the dolomite material bed 126 and the flow rate through the re-mineralizer 124.

Any excess CO₂ that does not react with the dolomite material bed 126 will form carbonic acid (H₂CO₃), causing the pH of the flow of water 127 to drop. At a constant flow rate, therefore, a reduction in the pH of the flow of purified, re-mineralized water 127 downstream of the re-mineralizer 124 will thus indicate that too much CO₂ is being injected, and thus that it is possible to decrease the CO₂ injection.

Thus, the operation of the dosing valve 120, and as a result the injection of CO₂, is governed by a feedback loop 132 which is at least partially dependent on the output of the conductivity sensor 128 and the pH sensor 130. In this way, a constant level of dissolved ions in the flow of purified, re-mineralized water 127 is maintained.

Moreover, it will be recognized that this feedback loop 132 may form part of a larger control system, which may be adapted to measure and adjust the volumetric flow rates of the water and the CO₂ for optimal re-mineralization and output, and to determine when the dolomite material bed 126 needs to be replenished and inform an operator accordingly.

Finally, the flow of purified, re-mineralized water 127 is conducted out of the apparatus 100, represented here schematically by an output 134. The output 134 may be a structure for the storage, distribution, or use of the purified, re-mineralized water 127, or may be an apparatus for further treatment or processing, e.g. by the infusion of a flavouring concentrate.

As can be seen from the previous description, conductivity, pH and residence time are key parameters for the production of the claimed purified, re-mineralized water as well as the balance between these parameters.

In particular, the purified, re-mineralized water 127 can be treated again with ozone for maximal disinfection effectiveness. Unlike the mineral salts used in the processes known in the art, the dolomite contains no bromine and there is thus no danger of producing carcinogenic bromate through an additional ozonation step.

In any case, the purified, re-mineralized water 127 that is produced is very stable and consistent in terms of its calcium, magnesium, and bicarbonate composition. Moreover, the intervals for replenishing the dolomite material bed 126 are much longer, compared to the mineral-salt-infusion methods known in the art.

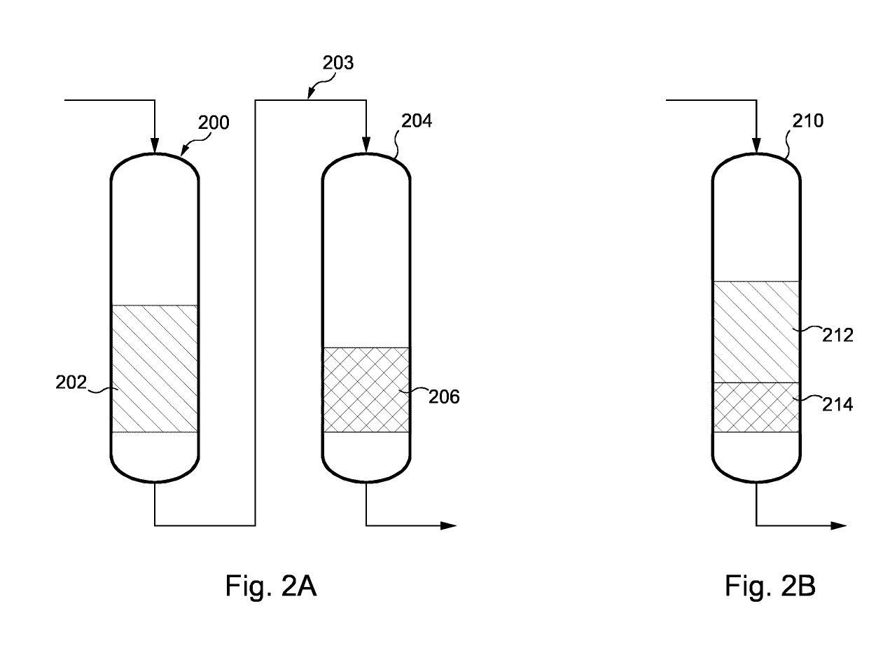

To this end, FIG. 2A describes an example of such a situation, in a second embodiment of the invention. In this embodiment, there is provided a re-mineralizer 200 in the form of a filter column comprising a dolomite material bed 202, similar to that of the embodiment of FIG. 1. However, the output of the re-mineralizer 200, rather than being connected directly to an exit, conducts a flow of purified, re-mineralized water 203 to a manganese filter 204.

The manganese filter 204 serves to remove any contamination caused by the presence of manganese in the purified, re-mineralized water 203, in particular that which is a result of impurities in the natural dolomite material bed 202. Similar to the re-mineralizer 200, the manganese filter 204 is in the form of a filter column with a manganese dioxide bed 206.

As the purified, re-mineralized water 203 flows through the manganese dioxide bed 206, ionic manganese and manganese dioxide precipitate is removed, without otherwise affecting the mineral composition of the water.

In operation, it will be necessary to periodically regenerate the manganese dioxide bed 206 of the manganese filter 204. This can be done mechanically by backwashing the manganese filter 204 with demineralized water, subsequently conducting the backwash water away for disposal.

The regeneration may instead or additionally be performed by flushing the manganese filter 204 with a chlorine solution. These regeneration procedures may be performed according to the manner known in the art, which the person of skill in the art will be capable of adapting to the particular aspects of the implementation in question.

The regeneration of the manganese filter 204 will increase the efficiency with which the manganese dioxide bed 206 is consumed, and by extension increase the period of time between replenishments thereof.

FIG. 2B depicts a third embodiment of the invention, which is a variant on that presented in FIG. 2A. In FIG. 2B, the re-mineralizer and the manganese filter are combined in the same vessel, the filter column 210. The filter column 210 comprises a dolomite material bed 212 disposed in a layer on top of a manganese dioxide bed 214. The re-mineralization and manganese-removal functions of the apparatus are thereby combined into a single, compact unit.

To realize maximum performance and longevity, certain dimensional restrictions in the media 212, 214 must be respected. Specifically, the manganese dioxide bed 214 must have a particle size equal to or greater than that of the dolomite material bed 212, so as to prevent the mixing of the two media 212, 214 during operation, in particular during a backwashing procedure.

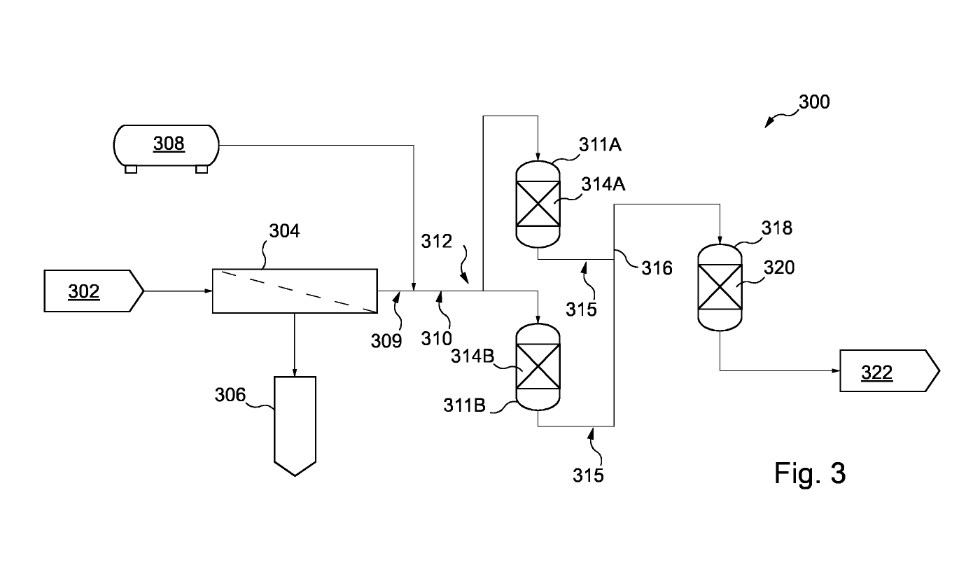

Turning now to FIG. 3, a fourth embodiment of the invention is depicted, comprising an apparatus 300.

As in the apparatus 100, there is provided a feedwater source 302, a reverse-osmosis filter 304 with a drain 306, and a CO₂ source 308 (the sensors, CO₂ injector, and dosing valve are omitted for clarity) injecting carbon dioxide into a flow of demineralized water 309 to create a flow of carbon-dioxide-enriched water 310

However, unlike the previously-discussed embodiments, the apparatus 300 is provided with two re-mineralizers, 311A and 311B, which are both fed with the flow of carbon-dioxide-enriched water 310 by way of a bifurcation 312.

Both of the re-mineralizers 311A and 311B contain a dolomite material bed 314A, 314B, which dissolves the desired ions into the carbon-dioxide-infused water as discussed above. Ideally, but not necessarily, the two re-mineralizers have equally-sized dolomite material beds 314A, 314B. In any event, the two re-mineralizers 311A, 311B each contribute to the mineral content of the purified, re-mineralized water that is proportionate to the relative sizes of their respective dolomite material beds 314A, 314B.

However, the fact that there are two re-mineralizers 311A, 311B means that the operator has a greater degree of flexibility in the operation of the apparatus 300. For instance, the re-mineralizers 311A, 311B may be sized so as to each be sufficient for the needs of the apparatus 300; as a result, one may be taken off-line e.g. to permit maintenance on the other. Such a configuration would also increase the amount of time between replenishments of the dolomite material beds 314A, 314B.

Once passed through the re-mineralizers 311A, 311B, a flow of purified, re-mineralized water 315 from each of the re-mineralizers 311A, 311B is merged at a bifurcation 316, and then conducted into a manganese filter 318, which comprises a manganese dioxide bed 320 and which functions in the manner described above. Following this, the water is discharged at an outlet 322, again as described above.

In the framework of FIG. 3, it has been described one manganese filter 318 positioned after the two re-mineralizers 311A, 311B. In an alternative, one could envisage to position one manganese filter after each re-mineralizers and then to have two manganese filters in the process. Such a solution would ease the maintenance of the whole system allowing to maintain one line while the other is still working.

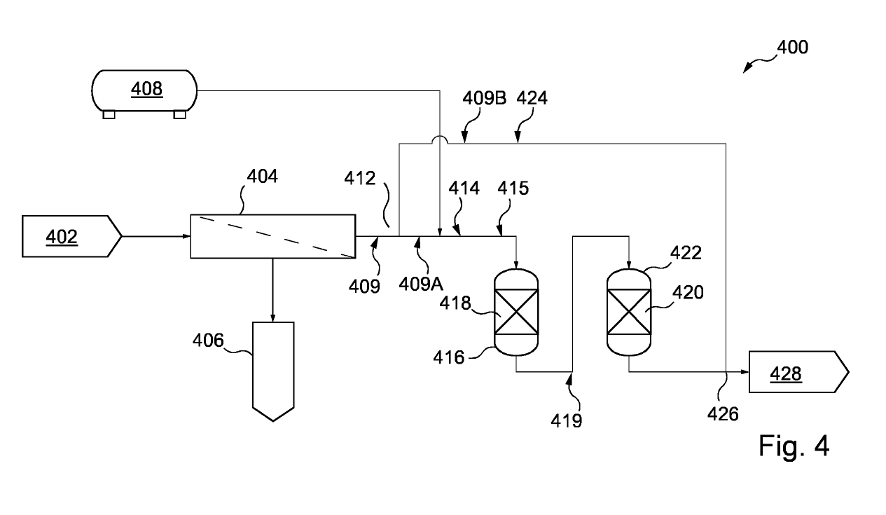

Finally, FIG. 4 depicts a fifth embodiment of the invention, in which there is an apparatus 400. As in the embodiments discussed above, the apparatus 400 also comprises a feedwater source 402, a reverse-osmosis filter 404 with a drain 406, and a CO₂ source 408 (as with FIG. 3, the sensors, CO₂ injector, and dosing valve are omitted for clarity).

Once a flow of demineralized water 309 exits the reverse-osmosis filter 404, it proceeds to a bifurcation 412, dividing the flow of demineralized water 409 approximately in two streams.

A first stream 409A of the demineralized water is conducted via a first branch 414 where, CO₂ is injected to turn it into a flow of carbon-dioxide-enriched water 415. This flow of carbon-dioxide-enriched water 415 is subsequently conducted into a re-mineralizer 416, wherein it flows through a dolomite material bed 418 and is re-mineralized in the manner described above to form a flow of purified, re-mineralized water 419.

The purified, re-mineralized water 419 flowing through the first branch 414 is then conducted through a manganese filter 420, wherein a manganese oxide bed 422 removes residual manganese ions and precipitates.

A second stream 409B of the flow demineralized water is conducted through a second branch 424, which bypasses the re-mineralizer 416 and the manganese filter 420. The two halves of the flow of water are re-combined at a bifurcation 426, and then conducted to an outlet 428.

It should be mentioned that the two streams may be equal or not according to the parameters of the process.

It will be apparent that, since only part of the flow of water is sent through the first branch 414, the re-mineralizer 416 must dissolve the calcium, magnesium, and bicarbonate ions to a concentration twice the desired final concentration. However, such a configuration is advantageous in that it permits a great economy of size relative to the embodiment depicted in FIG. 3.

In particular, the manganese filter 420 can be smaller than the magnesium filter 318 of FIG. 3. Moreover, while the re-mineralizers 311A, 311B, and 416 are all substantially the same size for a given output of purified, re-mineralized water, the embodiment depicted in FIG. 4 requires only one of them.

The embodiment presented in the figures uses a reverse-osmosis step to demineralized the feedwater but if the feedwater is already poorly mineralised or considered as demineralized, said reverse-osmosis step is not mandatory.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

1. A method for providing purified, re-mineralized water in calcium and magnesium ions, comprising the steps of:
providing a flow of feedwater;
purifying and/or demineralizing said feedwater by a purifying and/or demineralizing process, thereby producing a flow of purified demineralized water;
injecting carbon dioxide into the purified, demineralized water, thereby producing a flow of carbon-dioxide-enriched water; and
passing the carbon-dioxide-enriched water through a re-mineralizer comprising a dolomite medium, thereby producing a simultaneous remineralizing of the water in calcium and magnesium leading to a flow of purified, re-mineralized water.

2. The method according to claim 1, comprising measuring the conductivity and/or pH of the purified, re-mineralized water for controlling the injection of carbon dioxide into the demineralized water.

3. The method according to claim 1, comprising passing the flow of purified, re-mineralized water through a manganese filter.

4. The method according to claim 3, wherein the manganese filter comprises a manganese dioxide medium.

5. The method according to claim 3, comprising periodically regenerating or replacing the manganese filter.

6. (canceled)

7. An apparatus for providing purified, re-mineralized water in calcium and magnesium ions, comprising a feedwater source for providing a flow of feedwater, and a purification and/or demineralizing apparatus for purifying and/or demineralizing the feedwater, thereby producing a flow of purified, demineralized water, a carbon dioxide injector configured to inject carbon dioxide into the flow of purified, demineralized water, and a re-mineralizer located downstream of the carbon dioxide injector and comprising a dolomite medium.

8. The apparatus according to claim 7, comprising a conductivity sensor and a pH sensor each located in the flow of purified, re-mineralized water at an outlet of the re-mineralizer, such that the operation of the carbon dioxide injector is governed by a feedback loop at least partially dependent on the output of said conductivity sensor and said pH sensor.

9. The apparatus according to claim 7, wherein the re-mineralizer comprises two filter columns disposed in parallel, each of said filter columns comprising a bed of dolomite medium.

10. The apparatus according to claim 7, wherein the re-mineralizer comprises a single filter column comprising a bed of dolomite medium, and a bypass line diverting a portion of the flow of demineralized water around the filter column.

11. The apparatus according to claim 7, comprising a manganese filter located downstream of the re-mineralizer.

12. The apparatus according to claim 11, wherein the manganese filter comprises a manganese dioxide medium.

13. The apparatus according to claim 11, wherein the manganese filter and the re-mineralizer are disposed in a filter column, the filter column comprising a bed of dolomite medium and a bed of manganese dioxide medium having a grain size equal to or greater than the grain size of the dolomite medium.
